(19) United States
(12) Patent Application Publication
(10) Pub. No.: US 2023/0054605 A1
(43) Pub. Date: Feb. 23, 2023

(54) ANTI-PEEP SYSTEM AND AUTOMATED TELLER MACHINE WITH ANTI-PEEP MECHANISM

(71) Applicant: LITEMAX ELECTRONICS INC., New Taipei City (TW)

(72) Inventor: CHING-CHANG CHEN, New Taipei City (TW)

(21) Appl. No.: 17/403,904

(22) Filed: Aug. 17, 2021

(51) Int. Cl. G06Q 20/10; G02B 27/28

(52) U.S. Cl. CPC G06Q 20/1085; G02B 27/286

(57) ABSTRACT

An anti-peep system applicable to an automated teller machine (ATM), which includes a main body and a display screen mounted on the main body. The anti-peep system includes a sensor and an anti-peep unit. The sensor includes a housing and a sensing element set in the housing; the housing is provided on the main body of the ATM, and the sensing element is used to sense whether there is an object located in an area in front of the display screen. The anti-peep unit is integrated into the display screen and electrically connected to the sensing element of the sensor. The anti-peep unit is enabled or disabled according to a sensing result of the sensing element to selectively shield the display screen.

### BACKGROUND OF THE INVENTION

### 1. Field of the Invention

The present disclosure relates to an anti-peep technique, and more particularly, to an anti-peep system and an automated teller machine (ATM) with anti-peep mechanism.

### 2. Description of the Related Art

The introduction of the automated teller machine (ATM) into people's daily life largely reduces the frequency at which people need to go banks. However, there is the risk of leaking someone's private information when he/she is operating the ATM. For instance, other people standing near the ATM being operated might take a peep at the operator's password and balance shown on the screen of the ATM.

Privacy filters have been widely applied to computer screens. The privacy filter may also be applied to the screen of the ATM to prevent people other than the operating person in front of the ATM from taking a peep at the information shown on the screen of the ATM. However, the privacy filter being fixedly attached to the ATM screen would reduce the effect of propaganda or advertising videos on avoiding scams that are normally played on the ATM when it is not operated by a user.

### BRIEF SUMMARY OF THE INVENTION

An objective of the present disclosure is to provide an anti-peep system and an automated teller machine (ATM) with anti-peep mechanism, so as to simultaneously achieve the purposes of providing effective anti-peep effect when the ATM is being used and clearly playing propaganda or advertising videos on avoiding scams when the ATM is not operated by a user.

To achieve at least the above objective, a first aspect of the present disclosure is to provide an anti-peep system applicable to an ATM that includes a main body and a display screen mounted on the main body. The anti-peep system includes a sensor and an anti-peep unit. The sensor includes a housing and a sensing element set in the housing; the housing is provided on the main body of the ATM, and the sensing element is used to sense whether there is an object located in an area in front of the display screen. The anti-peep unit is integrated into the display screen and electrically connected to the sensing element of the sensor. The anti-peep unit is enabled or disabled according to a sensing result of the sensing element to selectively shield the display screen.

A second aspect of the present disclosure is to provide an automated teller machine (ATM) with anti-peep mechanism. The ATM includes a main body, a display screen and an anti-peep system.

In an embodiment, the sensing element of the sensor is an infrared transceiver unit.

In an embodiment, the sensing element of the sensor is a camera.

In an embodiment, the anti-peep unit includes at least one polarizing plate and a polarization control circuit. The polarization control circuit is electrically connected to between the polarizing plate and the sensing element.

With the above arrangements, both the anti-peep system and the ATM with anti-peep mechanism according to the present disclosure include a sensor for sensing whether there is a person located in an area F in front of the display screen to operate the ATM; and an anti-peep unit of the anti-peep system is enabled or disabled according to the sensing result of the sensor. Thus, both the anti-peep system and the ATM of the present disclosure can simultaneously achieve the purposes of providing effective anti-peep effect when the ATM is being used and clearly playing propaganda or advertising videos on avoiding scams when the ATM is not operated by a user.

### BRIEF DESCRIPTION OF THE DRAWINGS

FIG. 1 is a block diagram of an anti-peep system according to an embodiment of the present disclosure.

FIG. 2 is a schematic view of an automated teller machine with anti-peep mechanism according to an embodiment of the present disclosure.

### DETAILED DESCRIPTION OF THE INVENTION

To facilitate understanding of the objects, characteristics and effects of this present disclosure, embodiments together with the attached drawings for the detailed description of the present disclosure are provided. It is noted the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

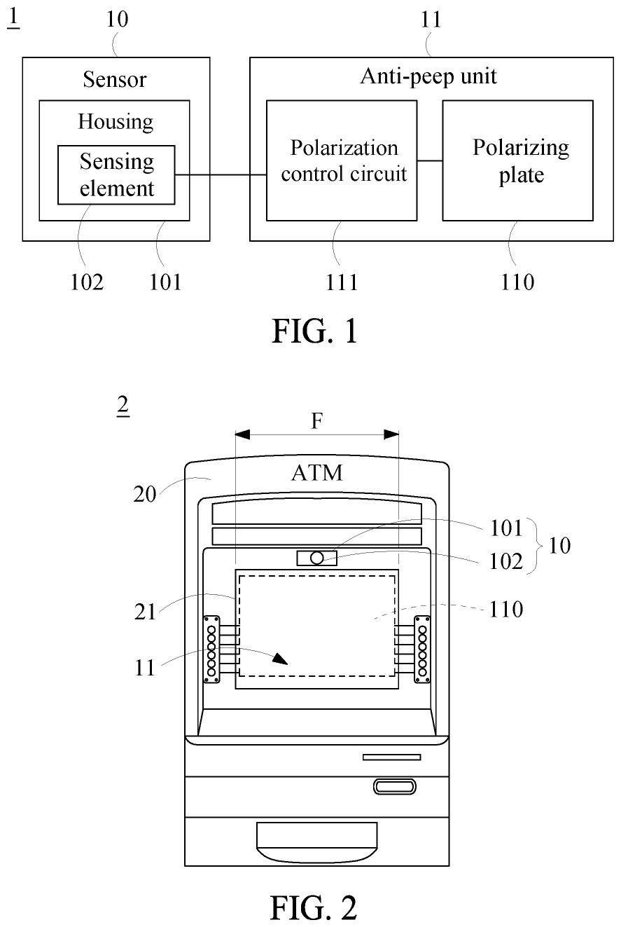

Please refer to FIGS. 1 and 2. A first aspect of the present disclosure provides an anti-peep system 1, which is applicable to an automated teller machine (ATM) 2. The ATM 2 includes a main body 20 and a display screen 21 mounted on the main body 20. The anti-peep system 1 includes a sensor 10 and an anti-peep unit 11. The sensor 10 includes a housing 101 and a sensing element 102 set in the housing 101. The housing 101 is provided on the main body 20 of the ATM 2. The sensing element 102 is used to sense whether there is an object, such as an operator, located in an area F in front of the display screen 21. The anti-peep unit 11 is integrated into the display screen 21 and is electrically connected to the sensing element 102 of the sensor 10. The anti-peep unit 11 is enabled or disabled according to a sensing result of the sensing element 102 to selectively shield the display screen 21.

A second aspect of the present disclosure provides an automated teller machine (ATM) 2 with anti-peep mechanism. The ATM 2 includes the above-mentioned main body 20, display screen 21, and anti-peep system 1.

As having been mentioned above, both the anti-peep system 1 and the ATM 2 with anti-peep mechanism according to the present disclosure include a sensor 10 for sensing whether there is a person located in an area F in front of the ATM 2 to operate the ATM 2. The anti-peep unit 11 of the anti-peep system 1 is enabled if a person is found in front of the ATM 2, or is disabled if no person is found in front of the ATM 2. Thus, the display screen 21 of the ATM 2 in use is effectively protected against peep and can still clearly play propaganda or advertising videos on avoiding scams when the ATM 2 is not operated by someone.

As shown in FIGS. 1 and 2, in an operable embodiment, the sensing element 102 of the sensor 10 can be an infrared transceiver unit or a camera without being specifically limited thereto. The anti-peep unit 11 can include at least one polarizing plate 110 and a polarization control circuit 111. In an embodiment, the polarization control circuit 111 is electrically connected to between the polarizing plate 110 and the sensing element 102, however, without being particularly limited thereto. When the sensing element 102 senses that a person (not shown) enters the area F in front of the ATM 2 to operate the latter, the sensing element 102 informs the polarization control circuit 111 for the same to drive the polarizing plate 110 to polarize a light source of the display screen 21, such that persons located at two lateral sides of the area F in front of the ATM 2 could not see any information shown on the display screen 21. The polarizing plate 110 can be provided on a backlight module (not shown) of the display screen 21, and one or more pieces of polarizing plates 110 can be provided according to actual need. In the case the display screen 21 is a liquid crystal display (LCD) screen; one or more polarizing plates 110 can be further provided in addition to the polarizing plates 110 provided at the two lateral sides of the LCD screen. Moreover, to avoid the anti-peep system 1 from being so sensitive that it is frequently enabled and disabled, the enabling or disabling of the anti-peep system 1 may also be determined further according to whether an ATM card has been inserted into the ATM 2. In other words, the anti-peep system 1 is enabled only when there is an operating person located in the area F in front of the ATM 2 and an ATM card is inserted into the ATM 2. And, once the anti-peep system 1 is enabled, it keeps in the enabled state so long as the ATM card is being inserted in the ATM 2. With this design, the anti-peep system 1 would not become disabled and the information on the display screen 21 is not subjected to the risk of being peeped even if the operating person bends down to pick up something during the operating process and is temporarily not sensed by the sensor 10.

While the present disclosure has been described by means of specific embodiments, numerous modifications and variations could be made thereto by those skilled in the art without departing from the scope and spirit of the present disclosure set forth in the claims.

What is claimed is:

1. An anti-peep system being applicable to an automated teller machine (ATM), which includes a main body and a display screen mounted on the main body, comprising:
a sensor including a housing and a sensor element set in the housing; the housing being provided on the main body of the ATM, and the sensing element being used to sense whether there is an object located in an area in front of the display screen; and
an anti-peep unit being integrated into the display screen and electrically connected to the sensing element of the sensor; and the anti-peep unit being enabled or disabled according to a sensing result of the sensing element to selectively shield the display screen.

2. The anti-peep system according to claim 1, wherein the sensing element of the sensor is an infrared transceiver unit.

3. The anti-peep system according to claim 1, wherein the sensing element of the sensor is a camera.

4. The anti-peep system according to claim 1, wherein the anti-peep unit includes at least one polarizing plate and a polarization control circuit; and the polarization control circuit being electrically connected to between the polarizing plate and the sensing element.

5. An automated teller machine (ATM) with anti-peep mechanism, comprising:
a main body;
a display screen being mounted on the main body;
a sensor including a housing and a sensing element set in the housing; the housing being provided on the main body of the ATM, and the sensing element being used to sense whether there is an object located in an area in front of the display screen; and
an anti-peep unit being integrated into the display screen and electrically connected to the sensing element of the sensor; and the anti-peep unit being enabled or disabled according to a sensing result of the sensing element to selectively shield the display screen.

6. The ATM with anti-peep mechanism according to claim 5, wherein the sensing element of the sensor is an infrared transceiver unit.

7. The ATM with anti-peep mechanism according to claim 5, wherein the sensing element of the sensor is a camera.

8. The ATM with anti-peep mechanism according to claim 5, wherein the anti-peep unit includes at least one polarizing plate and a polarization control circuit; and the polarization control circuit being electrically connected to between the polarizing plate and the sensing element.
